(19) United States
(12) Patent Application Publication
(10) Pub. No.: US 2019/0389206 A1
(43) Pub. Date: Dec. 26, 2019

(54) USING NOZZLE IDLE TIME TO DETERMINE MAINTENANCE PRINTING FLUID EJECTION

(71) Applicant: Hewlett-Packard Development Company, L.P., Spring, TX (US)

(72) Inventors: Bradley D Chung, Corvallis, OR (US); David E De Bellis, Corvallis, OR (US); Lisa A Underwood, Corvallis, OR (US)

(21) Appl. No.: 16/481,362

(22) PCT Filed: Mar. 23, 2017
(86) PCT No.: PCT/US2017/023799

§ 371 Date: Jul. 26, 2019

(51) Int. Cl. B41J 2/045; B41J 25/308

(52) U.S. Cl. CPC B41J 2/04573; B41J 25/308; B41J 2/04581; B41J 2/0458

(57) ABSTRACT

A process for servicing and maintaining nozzles of a print head may comprise determining an idle time of a nozzle. The determined nozzle idle time may be used as part of printing fluid drop ejection.

### BACKGROUND

In certain types of situations, signals or states may be received at a printing device and a printing substance (e.g., a fluid) may be deposited on a substrate responsive to the received signals or states. A printing substance may exit the printing device via an output mechanism, which may comprise a nozzle. There may be a number of things that might occur with respect to the output mechanism to affect print quality. For instance, bubbles of a printing fluid (e.g., ink) may form in the nozzle, printing fluid may dry in the nozzle, and contaminants may be introduced into the nozzle, by way of example. Some processes for servicing and maintaining nozzles may reduce print throughput.

### BRIEF DESCRIPTION OF THE DRAWINGS

Various examples will be described below by referring to the following figures.

FIG. 1 is an illustration of an example system for servicing a print head;

FIG. 2 is an illustration of an example system for depositing a printing substance on a substrate and servicing a print head;

FIG. 3 illustrates an example print job having a number of page gaps;

FIG. 4 is a flow chart for an example method for servicing a nozzle; and

FIGS. 5 and 6 are flow charts illustrating example methods for servicing a nozzle.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

At times, printing fluid output mechanisms of printing devices, such as print head nozzles of thermal ink jet (TIJ) printers, piezo print head printers, etc., may be exposed to the atmosphere. For consistency, output mechanisms are referred to herein as nozzles. Due to atmospheric exposure, contaminants (e.g., dust, plastic, metal, and paper fragments, etc.) may be introduced into the nozzles, remnant printing fluid may dry, or bubbles may form, by way of example. The presence of such contaminants may have an impact on print quality. Maintenance may be performed on printer nozzles to keep the nozzles operating as desired. Sample nozzle maintenance can include nozzle flushing, for example, to remove contaminants, air bubbles, and dried printing fluid. This maintenance can occur at a dedicated capping, wiping, and spitting station (e.g., a printer service station) of a printing device, by way of example. In some cases, however, time spent maintaining print nozzles at a dedicated service station can limit printing throughput. For instance, printing may pause momentarily while a nozzle is serviced, and due to a number of interruptions aggregated throughout a print job, the time taken to print may increase, for example. In order to reduce an impact of servicing print nozzles on throughput, periodic flushing may occur on a substrate or in page gaps. However, flushing nozzles on a page or in a page gap may present certain challenges. For instance, printing fluid drops from nozzle flushing on a page may reduce print quality. Also, nozzle flushing can, in some cases, be considered wasteful, such as by potentially expelling printing fluid unnecessarily. For instance, some processes for nozzle maintenance include flushing all nozzles of a printing device at intervals independent of nozzle use. By way of example, nozzles may be flushed upon startup and at intervals of a print job (e.g., every 5 pages).

Such nozzle maintenance may be unnecessary for all nozzles. By way of example, certain nozzles may not be used in a print job (e.g., color nozzles may not be used in a black and white or grayscale print job, or black nozzles may not be used in a color print job, etc.). It may be desirable, therefore, to reduce time and resources spent flushing unused nozzles. Thus, one process for reducing printing fluid waste due to nozzle flushing may comprise analyzing a received print job to determine a subset of nozzles to flush. However, processes that attempt to restrict flushing to those nozzles determined to be used in a print job may potentially reduce throughput due for instance, to time spent processing print job data and may be processor-intensive. For instance, a few milliseconds may be available within a page gap to flush nozzles and throughput may be reduced in order to have enough time to analyze a print job (e.g., print data), determine which nozzles are to be used, and queue up instructions to flush the desired nozzles.

The present disclosure proposes using nozzle idle time (e.g., rather than print data) to determine which nozzles to flush and when. In one example, a nozzle idle time may be determined by aggregating time spent since a nozzle was last used. In another example, a nozzle idle time may be determined by predicting nozzle idle time based on page speed (e.g., which may be used to determine a time since a nozzle will have last been used). The nozzle idle time determination may be used to make nozzle maintenance determinations. For instance, in one implementation, nozzle flushing may comprise ejecting 9 drops of printing fluid. However nozzle idle time may be used in one case to vary a number of printing fluid drops to eject as part of a nozzle flushing process. By way of further example, in one implementation, nozzle flushing may occur at regular fixed intervals, such as every 4 pages, by way of non-limiting example. However, in one case, intervals at which a particular nozzle is serviced may be varied based on nozzle idle time. Thus, nozzle maintenance can include varying a number of printing fluid drops discharged by a nozzle (e.g., fewer than 9 drops based on the nozzle idle time) or can include varying a time between nozzle flushing (e.g., putting off a flushing cycle because an idle time threshold has not been met).

To illustrate, for example, if a fixed page gap nozzle flushing routine would flush nozzles with a fixed number of drops of printing fluid every 4 pages, one process for nozzle maintenance may include using an idle timer for a nozzle and varying a number of printing fluid drops ejected in page gaps. In this example, the idle timer may be reset or zeroed as the nozzle to which the idle timer corresponds is used in a print job. The idle timer may also be incremented in cases in which the nozzle is not used. A time taken to print a preceding page may be added to values in the idle timer, and the resulting value may be used to vary a number of drops to eject, such as in a 4 page flushing routine (e.g., approximately 1 drop per second idle, by way of non-limiting example).

In another example, it may be possible to predict print time for an upcoming portion of a print job (e.g., predicting print time of a page), and the predicted print time may be added to an idle timer for a particular nozzle. Prior to printing the upcoming page, the resulting value of the idle timer can be compared with an idle timer threshold and the nozzle can be flushed in the next page gap if the threshold has been exceeded. In one implementation of such a process, rather than varying a number of printing fluid drops to eject, nozzle servicing intervals may be varied for a nozzle. Thus, for example, a nozzle for which an idle timer threshold is not exceeded may forego nozzle maintenance.

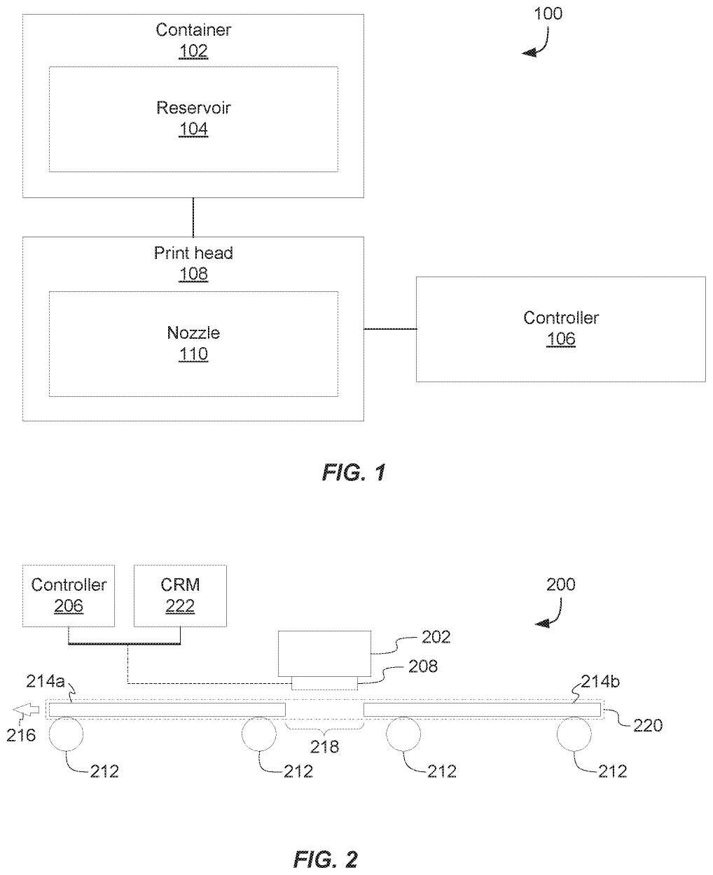

Turning to FIG. 1, a sample system 100 is presented having a container 102, a print head 108, and a controller 106. Sample system 100 may be capable of using measures of nozzle idle time to vary nozzle maintenance and servicing (e.g., nozzle flushing), such as by varying a number of printing fluid drops to eject per servicing interval or varying a service interval frequency, by way of non-limiting example. For example, system 100 may comprise a system for printing on a substrate. Container 102 may comprise a mechanism capable of interfacing with print head 108, such as via a fluid conduit, and may comprise a reservoir 104 for retaining a printing substance, such as printing fluid. Print head 108 may comprise a mechanism for enabling retrieval of the printing substance from container 102. For example, print head 108 may comprise one or more integrated circuits (ICs), capable of transmitting signals responsive to which a portion of the stored printing substance may travel from container 102 to print head 108. The printing substance received from container 102 may be ejected through nozzle 110. For example, in one implementation, drops of printing fluid may be ejected from nozzle 110 onto a print substrate. In one example, printing fluid may be caused to leave nozzle 110 responsive to temperatures changes (e.g., a thermal ink jet print head, without limitation). At times, container 102 and print head 108 may comprise an integrated print head and container unit. At other times, container 102 may be replaceable with respect to print head 108. Controller 106 may comprise a plurality of circuits, such as ICs, capable of executing instructions, such as to enable printing on a print substrate and servicing nozzle 110. For example, controller 106 may comprise a central processing unit (CPU), a field programmable gate array (FPGA), or an application-specific integrated circuit (ASIC), by way of non-limiting example. Controller 106 may be arranged in print head 108. In other example cases, controller 106 may be arranged in a printer housing and may be in electrical communication with print head 108, such as able to receive signals from and transmit signals to print head 108. Controller 106 may be capable of, for example, using nozzle idle time to offer dynamic service of nozzle 110, such as including varying a number of drops of printing fluid to eject in a page gap, or varying a page gap service interval, by way of example.

In one case, instructions may be executed by controller 106 to track idle time of nozzles of a printing fluid delivery system, such as system 100. Controller 106 may receive, for example, a clock signal that may be used to determine an amount of time that a nozzle has been idle. An idle timer may be reset or set to zero at a time at which nozzle 110 is used (e.g., ejects printing fluid drops). The received clock signal may be used to increment the idle timer. The idle timer values may be used to determine whether to service nozzle 110 in a next page gap and may also be used to determine a number of printing fluid drops to eject from nozzle 110 as part of a service routine, as shall be described hereinafter using FIG. 2.

FIG. 2 illustrates an example system 200 for applying a printing substance, such as printing fluid, to a substrate. FIG. 2 shows, for example, a container 202 and a print head 208 arranged to be able to deposit printing substances upon substrates, such as substrates 214a and 214b that may be moved within a path of print head 208. Controller 206 and computer-readable medium (CRM) 222 may be arranged in print head 208, or may be arranged externally to print head 208 and may be in communication therewith (e.g., via a wired or wireless communication channel). Signals or states representing images or text to be deposited on a print substrate may be received at controller 206 and are referred to herein as a print job. Controller 206 may enable conversion of the print data into printing substance (e.g., printing fluid) deposited on substrates (e.g., substrates 214a and 214b). Thus, in the context of print data, a print job can comprise signals or states indicative of text or images to be output to a substrate via print head 208. And in the context of substrate and printing substances, a print job may refer to a number of pages onto which printing material has been (or may be) deposited via print head 208, such as illustrated by print job 220.

FIG. 2 also shows movement of example substrates 214a and 214b, such as by rolling substrate advancement mechanisms 212, in relation to container 202 and print head 208, as illustrated by arrow 216. Substrates 214a and 214b may include paper, by way of illustration. In one example, instructions may be fetched from a computer-readable medium (CRM) 222, to enable print of a print job and nozzle maintenance, by way of example.

In one example, substrate advancement mechanisms 212 may comprise rollers and may pull substrate in a print path of print head 208, such as responsive to instructions executed by controller 206. For instance, substrate 214a and 214b may be pulled in the path of print head 208 (e.g., in a direction indicated by arrow 216) as part of a print job 220 (e.g., a combination of printing substance deposited, or to be deposited, on substrates responsive to signals and states representing image and text to deposit on a substrate). At a point in print job 220 illustrated in FIG. 2, printing fluid may have already been deposited on substrate 214a as part of print job 220, and printing fluid may yet be deposited on substrate 214b. In this example, fewer than all of the nozzles of print head 208 may have been used in applying printing fluid to substrate 214a. Based on idle times for the nozzles of print head 208, it may be determined that a subset of the nozzles of print head 208 may be due for servicing, such as by way of a maintenance printing fluid ejection, in page gap 218.

In one example approach, a nozzle idle time may indicate an amount of time that has passed since a nozzle (e.g., nozzle 110) of print head 208 was last used. If the nozzle was not used to eject printing fluid onto substrate 214a (or as part of a maintenance ejection), then the print time to print on substrate 214a may be added to any previous time values in an idle timer (e.g., stored in CRM 222). If nozzles are to be serviced in page gap 218, then the idle timer value may be used to determine a number of drops of printing fluid to eject from the nozzle (e.g., nozzle 110). For example, if the nozzle has been idle for approximately five seconds, then it may be determined that five printing fluid drops are to be ejected in page gap 218. And the idle timer for a nozzle may be reset after the nozzle is finished.

In another example, a speed at which substrate 214b advances may be used in conjunction with dimensions of substrate 214b to predict a print time for substrate 214b. The predicted print time for substrate 214b may be added to an idle time in an idle timer for a nozzle (e.g., nozzle 110). The resultant value may be compared with an idle time threshold. If the idle time value exceeds the idle time threshold, maintenance of the nozzle may be performed (or be scheduled to be performed), such as in page gap 218.

For simplicity, the present disclosure uses examples in which a print head is stationary. This is done to simplify the discussion and is not intended to restrict the breadth of claimed subject matter, unless expressly stated otherwise. As such, claimed subject matter is intended to read on print heads that scan across a substrate as part of a process to apply printing fluid to the substrate. At times, then, maintenance printing fluid ejection may occur at a predefined location, such as to catch ejected printing fluid in a spittoon (not shown). For instance, in one example in which print head 208 scans across substrates 214a and 214b to apply printing fluid as part of a print job, a spittoon may be arranged at a first position in a scanning path. Thus, maintenance printing fluid ejections may occur (or be scheduled to occur) over the first position. Print head 208 may scan across substrates 214a and 214b and potential maintenance ejections may be limited to the first position at which the spittoon is arranged (e.g., every two passes by print head 208, in one example, into the spittoon). It is to be understood, therefore, that in this example, printing fluid maintenance ejections may occur at times other than in page gaps. For instance, printing fluid maintenance ejections may be scheduled to occur at fixed numbers of scanning passes (e.g., every 10 passes). Consistent with the foregoing discussion, however, in one example, a number of printing fluid drops ejected over the spittoon may vary based on idle time. In another example, printing fluid maintenance ejection intervals may vary based on idle time. As such, the following discussion of varying printing fluid drops to eject and varying maintenance intervals is intended to also apply to cases involving scanning print heads, for example.

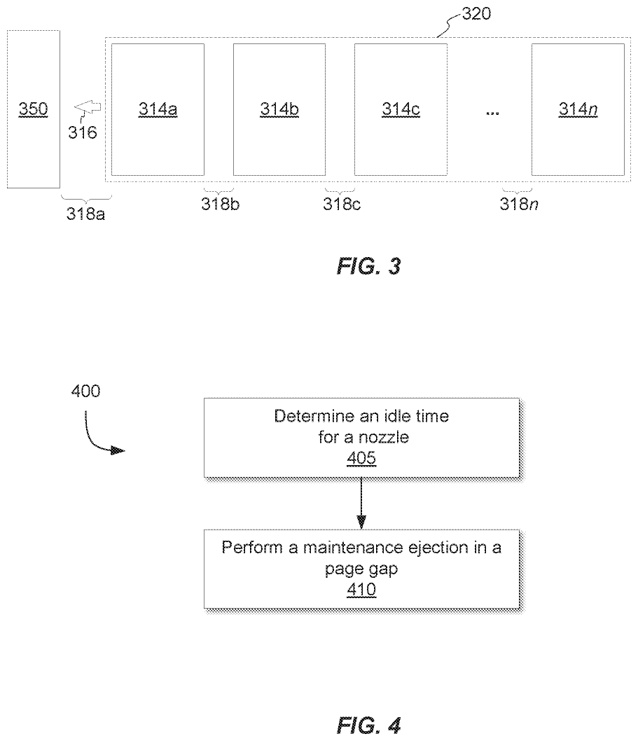

In order to illustrate example nozzle servicing, such as in a multi-page print job, FIGS. 3 and 4 are used in the following discussion. For example, FIG. 3 illustrates a print job 320 comprising n pages, represented by substrates 314a-314n. In one example, substrates 314a-314n may move within a path of print bar 350 (e.g., comprising containers and print heads to print images and text), as indicated by arrow 316. There may be a number of page gaps between substrates 314a-314n, as illustrated by page gaps 318a-318n. Elements of FIG. 3 will be referred to in conjunction with FIG. 4 to describe example operation of one implementation thereof.

In a particular example, nozzles of print head 350 may be serviced prior to beginning print job 320. This may be done at a nozzle service station, for example, rather than in page gap 318a by way of non-limiting example.

In another example, servicing nozzles of print bar 350 may occur between pages of print job 320. For example, at a block 405, an idle time may be determined for nozzles of print bar 350. Because fewer than all nozzles of print bar 350 may be used in depositing printing fluid on a particular substrate as part of a print job, an idle time for particular nozzles of print bar 350 may be different from an idle time for other nozzles of print bar 350. Thus, in one example, an idle timer may be used for each nozzle of print bar 350.

For a particular nozzle, determining an idle time may comprise determining a time taken to print a page of print job 320, such as on substrate 314a. In one case, an idle timer may already have a value and a time taken to print a page may be added to the existing value of the idle timer. The idle timer may increment until a page gap nozzle maintenance is performed or a nozzle is used to print a page of a print job, for example.

In another example, determining an idle time may comprise estimating a time to be taken to print a page of a print job 320, such as on substrate 314a. For example, in one case, a rate of travel of substrate 314a may be used in conjunction with a dimension of substrate 314a to estimate a time to be taken to print a portion of print job 320 corresponding to substrate 314a. As noted above, an idle timer may reset (e.g., may be zeroed out) responsive to use of a nozzle. In a case in which an idle timer has been reset, the predicted print time for a page may be added to the zeroed out idle time. In a case in which an idle timer has an existing value, the predicted print time for a page may be added to the existing value to yield an idle time.

At block 410, a page gap maintenance ejection may be performed based on a determined idle time. The page gap maintenance ejection may comprise ejecting one or more drops of printing fluid to flush contaminants, bubbles, and dry printing fluid, by way of example, out of a nozzle in a gap between pages of a print job (e.g., print job 320).

In a case in which an idle time is determined based on a time taken to print a preceding page, page gap maintenance ejection may be scheduled for a page gap between every ten pages, by way of non-limiting illustration. For a particular nozzle that has not been used in the last ten pages (e.g., with a throughput of approximately one page per second) as the scheduled maintenance ejection arrives, a determined idle time may be approximately ten seconds. Thus, in this example case, nine drops of printing fluid may be ejected from this particular nozzle in the scheduled page gap. However, for a particular nozzle that was last used two pages ago, a determined idle time may be approximately two seconds. Thus, in this example case, two drops of printing fluid may be ejected from this particular nozzle in the scheduled page gap. In one implementation, a look up table may be used to determine a correspondence between an idle time and a number of printing fluid drops to eject in a page gap maintenance ejection. By way of example, the relationship between idle time and printing fluid drops to eject in a page gap maintenance ejection may be such that for every second of idle time, approximately one drop of printing fluid is to be ejected in a page gap maintenance ejection. Of course, this is but an illustration of possible functionality and is not intended to be taken in a limiting sense.

For instance, in a case in which an idle time is determined based on a predicted print time for an upcoming page, a maintenance ejection may be performed at irregular intervals. Rather than performing nozzle maintenance at regular page gap intervals, as was the case for the example discussed in the preceding paragraph, page gap maintenance ejection may be scheduled for a particular nozzle in a next page gap based on whether the determined idle time exceeds a threshold. In a case in which a nozzle threshold is 20 seconds of idle time, an idle time may be compared to the threshold to determine whether the threshold is exceeded by the idle time (e.g., the idle time that comprises the predicted print time of the next page). In one implementation, such as to yield higher quality print output, page gap nozzle maintenance may be scheduled to avoid a nozzle idle time threshold from being exceeded for a particular nozzle. Thus, for example, for a nozzle threshold of 20 seconds, if a nozzle idle time for a particular nozzle is approximately 17 seconds and a predicted print time for a next page is 2 seconds, then it may be determined that an idle time threshold will not be exceeded, and a page gap nozzle maintenance ejection may not be scheduled for the page gap preceding the next page (e.g., the next page gap). However, if the nozzle idle time is approximately 17 seconds and the predicted print time for the next page is 5 seconds, then it may be determined that the idle time threshold will be exceeded in printing the next page. Thus, a page gap maintenance ejection may be scheduled for a next page gap. As print bar 350 aligns with the page gap in which the maintenance ejection is scheduled, a number of printing fluid drops may be ejected from the nozzle that exceeds the idle time threshold.

In an alternative example, both nozzle service intervals and printing fluid drop numbers may be varied. For example, a tiered threshold may be used and page gap maintenance ejections may be scheduled based on a level of the tiered threshold that may have been exceeded. Also, a number of printing fluid drops to eject may be selected based on the particular tier of the threshold. For example, an initial threshold may comprise 5 seconds, and no page gap maintenance ejections may be scheduled for idle times less than or equal to the threshold. A subsequent tier of the threshold may be 7 seconds. Five printing fluid drops may be ejected for idle times less than 7 seconds but greater than 5 seconds. Etc. Such tiered thresholds may save printing fluid in some cases, for example, such as by using fewer printing fluid drops per page gap maintenance ejection.

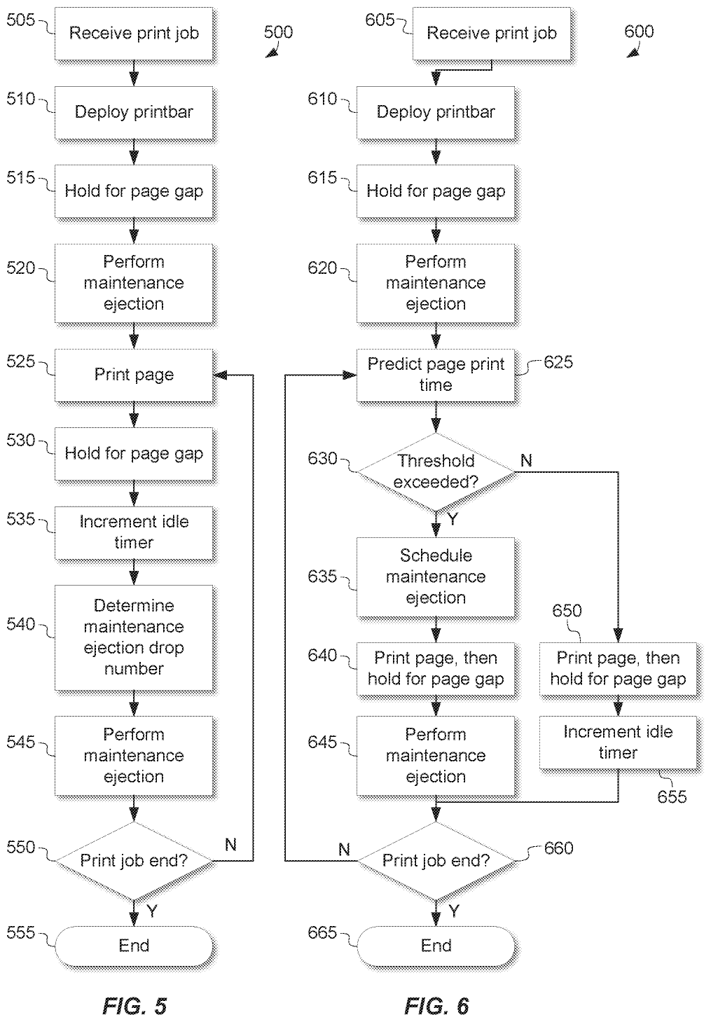

Example processes for determining idle time and performing nozzle maintenance are described in FIGS. 5 and 6. For example, in FIG. 5 an example method 500 is illustrated for performing nozzle maintenance. Method 500 may be performed independently for each nozzle of a print head.

In one example case, a print job may be received at a printer, such as shown at block 505 of FIG. 5. The print job may comprise signals or states indicative of text or images to be printed on a substrate and which may be used by the printer to determine a particular arrangement of printing fluid drops to eject by print head nozzles to correspond to the text or images of the print job. While not in use (e.g., prior to receiving a print job), the print bar (e.g., print bar 350) of the printer may be stored in a service station (e.g., capped). In one example, in response to reception of the print job, such as at block 505, the print bar may be deployed (e.g., uncapped), such as at block 510. Some implementations may be such that the nozzles of the printer may be fired in the service station. Other implementations may be such that an initial maintenance ejection may be performed in a gap before the first page of the received print job. As such, a nozzle maintenance routine may be held until the desired page gap is arranged under the print bar, such as shown at block 515.

As a page gap in which nozzle maintenance ejection is to be performed is aligned under the print bar, a nozzle maintenance routine may be run. Execution of the nozzle maintenance routine (e.g., by a processor) may cause drops of printing fluid to be ejected in the page gap, such as into a spittoon of the printer. At times, there may be a desire to perform an initial page gap nozzle maintenance ejection, such as illustrated at block 520, prior to printing a first page of a print job.

After an initial nozzle maintenance ejection, a first page of a print job may be printed, such as illustrated at block 525. In one example, nozzle maintenance may be scheduled at regular intervals (e.g., every 3 pages, every 4 pages, every 5 pages, etc.). Thus, in such an implementation, printing pages, such as illustrated at block 525, may include printing multiple pages. In another example, maintenance ejection of at least some nozzles may occur in every page gap. The printing and maintenance routine may be held, such as shown at block 530, until a page gap is aligned with a print head. As shown at block 535, an idle timer may be incremented. For example, a print time for the page printed (or the pages printed, as may be the case) at block 525 may be added to the idle timer.

As illustrated at block 540, the determined idle time (e.g., from the idle timer) may be used to perform a nozzle maintenance ejection. For example, in one case, an idle time may be used and a look up table may be consulted to determine a number of drops of printing fluid to eject in a page gap as part of a maintenance ejection. For a first nozzle, an idle time may be five seconds, and thus it may be determined that approximately five drops of printing fluid are to be ejected in the page gap as part of a maintenance ejection. For a second nozzle, an idle time may be zero seconds, and thus it may be determined that no drops are to be ejected in the page gap. For a third nozzle, an idle time may be twenty seconds, and thus it may be determined that approximately nine drops (e.g., such as in a case in which possible printing fluid drops range from 0 to 9) are to be ejected in the page gap. Etc. Using the maintenance ejection printing fluid drop determinations, the nozzles may be flushed in the scheduled page gap, such as illustrated at block 545.

If it is determined that the print job is done, such as illustrated at block 550, then the print and maintenance routine may end (e.g., at block 555). Otherwise, the routine may loop back to block 525 and continue until the print job is finished. In one case, after the print job is finished, the print heads may be returned to the service station for wiping and capping, for example.

As noted above, in another implementation, an idle time may be determined by predicting a print time for subsequent pages, such as illustrated by example method 600 in FIG. 6. At block 605, a print job may be received, similar to the above discussion. At block 610, a print bar may be deployed. For instance, print heads may be uncapped and an initial maintenance ejection may be performed, such as in a service station. At block 615, printing fluid ejection, such as part of a maintenance ejection routine, may be held until a page gap. Similar to the above discussion, nozzles may be flushed as part of an initial maintenance routine. In one example, a portion of nozzles to be used in the print job may be flushed (e.g., such as responsive to an indication that color is not to be used in a print job, color nozzles may not be flushed, and vice versa).

At block 625, a print time for a next page may be predicted. For instance, returning to FIG. 3 to illustrate, a print time for substrate 314a may be determined based on a speed of travel of substrate 314a (e.g., a measure of page speed) and a width of substrate 314a. Thus, for example, if substrate 314a measures 21 cm in width and is travelling at approximately 10 cm/second, it may be determined that a print time for substrate 314a will comprise approximately 2 seconds. The predicted print time may be compared with an idle time threshold, such as illustrated at block 630. In one example case, the idle time threshold may comprise 10 seconds. Thus, in this initial example, the idle time threshold will not be exceeded by the predicted print time of approximately 2 seconds. Thus, the page may be printed and then the printing and maintenance routine may be held, such as illustrated at block 650. The idle timer may be incremented to include the predicted page print time (and any page gap time), as illustrated at block 655.

If the print job is determined to be finished, as illustrated at block 660, the routine may end. Otherwise, it may return to block 625, to predict a print time for a next page. For instance, returning to FIG. 3, assuming that printing of substrate 314a has been completed, a print time for substrate 314b may be predicted, such as based on page rate of travel and width of substrate 314b. Assuming the same speed and dimensions as was predicted for substrate 314a, a predicted print time of approximately 2 seconds may also be determined for substrate 314b. If it is also assumed that negligible time passes in between pages (and thus ignore that time to simplify the present discussion), then the idle timer may increment by two seconds per page and it may not be until five pages have been printed that the idle time threshold of 10 seconds may be exceeded.

Assuming then that the predicted page print time, if added to the incremented idle time value will exceed the idle time threshold for a particular nozzle, as illustrated at block 630, it may be determined that a nozzle maintenance ejection is to be scheduled. Block 635 illustrates scheduling a maintenance printing fluid ejection. In one case, it may be determined that the maintenance ejection is to be performed in the page gap before the next page in order to avoid, if possible, exceeding the idle time threshold for a particular nozzle in printing the next page, for example. In another example, the maintenance ejection may be performed in a page gap after the next page, such as illustrated at block 640, such as to reduce printing fluid that may be potentially wasted in nozzle maintenance. The maintenance ejection may be performed in the scheduled page gap, as illustrated at block 645. In a case in which the maintenance ejection is performed prior to printing the page predicted to push the idle time over the idle time threshold, the page may be printed after performing the maintenance ejection. The routine may then return to block 660 at which point it may be determined whether the print job is done.

In the foregoing example methods 500 and 600, it is assumed for simplicity that maintenance ejections are to occur in a page gap. However, as noted above, in some cases, such as cases involving a scanning print head, maintenance ejections may occur at predetermined locations, such as into a spittoon. In such cases, example methods 500 and 600 apply as well with slight changes (e.g., omitting “hold for page gap” elements at blocks 515, 530, 615, 640, and 650). By way of further example, rather than looping after completing a page (e.g., blocks 525, 625, 640, and 650), process looping may occur after print head scan passes. By way of illustration, in one example case, a print job may be received at a device with a scanning print head, such as illustrated at block 505, and the print head may be deployed, such as shown at block 510. Block 515 may be omitted and an initial maintenance ejection may be performed (e.g., in a spittoon at a first position in a scanning path), such as shown at block 520. The print head may scan across the page in a first scanning path (e.g., block 525). Block 530 may be omitted. An idle timer may be incremented, such as illustrated at block 535, and a number of printing fluid drops may be determined for a possible maintenance ejection, such as illustrated at block 540. The number of printing fluid drops may be determined by consulting a lookup table, in one case. In one case, it may be determined that no maintenance ejection is to occur. In another case, it may be determined that printing fluid is to be ejected via one or more nozzles of the print head, such as illustrated at block 545. At block 550 it may be determined whether the print job has been finished and, if it has not, example method 500 may return to block 525 for subsequent scanning passes. Example method 600 may also be similarly altered to apply to a scanning print head example.

As discussed above, nozzle maintenance may comprise flushing a nozzle. Nozzle maintenance-related printing fluid use may be reduced by varying page gap service intervals, by varying a number of printing fluid drops to use in nozzle maintenance, or a combination thereof. In one example, a nozzle idle time may be determined and used to vary page gap service intervals, a number of printing fluid drops to use in nozzle maintenance, or a combination thereof.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A device comprising:
a controller to:
transmit a signal to eject, in a page gap, printing fluid drops from a printing fluid reservoir through a nozzle of a print head based on an idle time of the nozzle.

2. The device of claim 1, wherein the idle time is based on a print time for a previous page.

3. The device of claim 1, wherein the idle time is based on a measure of page speed.

4. The device of claim 1, wherein the controller is further to determine a number of drops of printing fluid to eject based on the idle time.

5. The device of claim 4, wherein the controller is further to determine the number of drops of printing fluid based on a print time of a page.

6. A non-transitory computer-readable medium having instructions stored thereon that when executed cause a processor to:
determine an idle time for a nozzle of a plurality of nozzles of a print head; and
perform a maintenance printing fluid ejection, in a page gap, from the nozzle based on the determined idle time.

7. The non-transitory computer-readable medium of claim 6, further comprising instructions that when executed cause the processor to:
predict a print time for a next page based on a measure of page speed; and
use the predicted print time to determine the idle time.

8. The non-transitory computer-readable medium of claim 6, further comprising instructions that when executed cause the processor to:
determine the idle time for other nozzles of the plurality of nozzles; and
perform a maintenance printing fluid ejection, in the page gap, from the other nozzles based on the determined idle time for the other nozzles.

9. The non-transitory computer-readable medium of claim 6, further comprising instructions that when executed cause the processor to:
increment an idle timer based on a determination that the determined idle time for the nozzle does not exceed a threshold.

10. A method comprising:
determining an idle time for a nozzle of a print head;
determining a maintenance printing fluid ejection schedule for the nozzle based on the determined idle time; and
ejecting printing fluid from a printing fluid reservoir based on the determined maintenance printing fluid ejection schedule.

11. The method of claim 10, further comprising, responsive to reception of signals indicative of a print job, reset an idle timer for the nozzle.

12. The method of claim 11, further comprising determining a predicted page print time based on a measure of page speed, and using the predicted page time and the idle timer to determine the idle time for the nozzle.

13. The method of claim 12, further comprising comparing the determined idle time for the nozzle with an idle time threshold, and scheduling a maintenance printing fluid ejection in the next page gap based on the comparison.

14. The method of claim 12, further comprising, responsive to a determination that the determined idle time for the nozzle does not exceed a threshold, incrementing the nozzle idle timer.

15. The method of claim 10, further comprising using a lookup table to determine a number of printing fluid drops to eject during a maintenance printing fluid ejection in a page gap based on the determined idle time.
